(19) United States
(12) Patent Application Publication
(10) Pub. No.: US 2002/0173980 A1
(43) Pub. Date: Nov. 21, 2002

(54) GPS-based system for handling information

(76) Inventors: Dennis G. Daggett, Winterset, IA (US); James K. Petersen, Winterset, IA (US); Gregory A. Livingston, Winterset, IA (US); John E. Sheeley, West Des Moines, IA (US); Brian E. Donoho, Urbandale, IA (US); John K. McGillicuddy, Clive, IA (US)

Correspondence Address: Michael C. Gilchrist, Dorsey & Whitney LLP, 801 Grand Avenue, Des Moines, IA, 50309, US

(21) Appl. No.: 09/860,861

(22) Filed: May 18, 2001

(51) Int. Cl. G06F 17/60

(52) U.S. Cl. 705/1

(57) ABSTRACT

A system for gathering and organizing land-related information by associating that information with GPS coordinates. The system maps an agricultural field and divides the map of the field into management zones. The boundaries of the management zones are defined by Geographic Positioning System (GPS) coordinates. The land within a management zone is homogenous with respect to risk factors related to crop failure. A Geographic Information System (GIS) record is created with respect to each management zone and fields of relevant agronomic information for that management zone are associated with the record. The GIS records associated with the system are useful in verifying carbon credits, and the mechanisms used to gather the information for the GIS records is useful for accumulating carbon credits.

### BACKGROUND

This invention relates generally to methods for increasing the profitability of insurance providers that provide crop insurance. Specifically, the disclosure describes a system for gathering information from farmers that helps insurance providers more accurately rate the risks associated with a group of crop insurance policies, and for encouraging farmers to engage in cultural farming practices that reduce the risk of crop failure. Even more particularly, the disclosure describes a system of gathering and organizing information that is associated with Global Positioning System (GPS) coordinates and managed in a Geographic Information System. The information helps the insurance providers to evaluate the risks associated with each insurance policy. The system is useful in helping farmers comply with reporting requirements. Furthermore, the system provides incentives for farmers to engage in land-friendly practices by facilitating the creation and functioning of a market for carbon credits.

Contrary to popular perception, crop insurance provides insurance against more than just weather problems. Some of the largest risks in crop insurance are the location, condition, and type of the underlying soil, and the management or husbandry practiced on the land. One of the most common types of crop insurance is Multiple Peril Crop Insurance (MPCI). Other available types of crop insurance include Crop Hail (CH) and Named Peril (NP) insurance. All MPCI policies are at least partially reinsured by the federal government, and heavily regulated. An insurance provider that provides MPCI cannot refuse to insure a farmer that presents a properly filled out insurance application. However, within a certain range, the insurance provider can determine what portion of the risk to insure itself and what portion to pass on to the federal government to reinsure. This is done by evaluating the various individual insurance policies and categorizing them according to their risk level. Each crop insurer must have a certain percentage of its policies within each specified risk category. However, the insurance provider can determine which policies to place in which categories. One of the most important factors in determining how profitable a crop insurer will be is how successful they are at properly evaluating and categorizing the various insurance policies in the appropriate risk category.

For example, in an MPCI policy that the insurance provider considers low risk, the insurance provider might insure 65% of the risk and the federal government 35% of the risk. The insurance provider and the government also split the premium accordingly. Similarly, if an MPCI policy is categorized as a high risk, the insurance provider might insure 10% of the risk and the federal government 90% of the risk, and the government and the insurance provider split the premium according to the same percentages. An insurance provider's profits are therefore increased when they can appropriately rank their MPCI policies according to risk level.

Presently with MPCI, the land on which crops are planted is identified by the entire insurable portion of land owned by the farmer. For example, if a single farmer owned and farmed an entire section (640 acres), that entire section would be a single insurable unit. However, within the section, the condition and risk factor of any location within that 640 acres can vary tremendously. For example, it could be that the eighty acres in the northwest portion of the section have very good soil with little chance of flooding. The eighty acres in the southeast corner of that same section may contain poor soil that is located in an area with a high risk of flooding. If the farmer is insuring eighty acres of corn planted on that section, the risk factor associated with that insurance policy will vary greatly, depending on where the farmer plants the corn. However, presently, the applicant would only indicate that eighty acres are being insured, and would not indicate which eighty acres; nor would the applicant provide any information related to the underlying condition of the soil in which the crops are planted.

As a result, insurance providers must rely only on the past performance of the land in question, and the past performance of other farms in the area in determining how to rate the risk of a particular MPCI insurance policy or group of policies. Insurance providers could increase their profitability if they were able to more accurately rank the risk associated with each insurance policy by gathering more specific information related to each policy.

As regulation of the farming enterprise increases, farmers will face increasing reporting requirements for different governmental purposes and agencies—i.e., Natural Resources Conservation Service (NRCS) of the U.S.D.A., for compliance with highly erodible land regulations, and Environmental Protection Agency (EPA) for compliance with groundwater regulations. While the exact content and format of the various reporting requirements may not be fully known, one central aspect will be the various practices associated with a specific plot of land. A system that allows the incorporation and reporting of various land-related data in an expeditious and cost effective manner is needed.

Naturally, insurance providers can also increase their profitability if they reduce the overall risk of crop failure on the farms they insure. Farms that practice land-friendly practices such as no-till or reduced tillage farming have an overall reduced risk of crop failure. Therefore, it is desirable for insurance providers to encourage these practices. These practices also have the added benefit of removing carbon dioxide from the atmosphere and sequestering it in the soil, so that the soil acts as a carbon storage device, sometimes referred to as a carbon sink. One possible incentive for farmers to convert to these land-friendly practices is a system of carbon credits (CCs) associated with a reduction in carbon dioxide emissions or a removal of carbon dioxide from the atmosphere. In some literature these carbon credits are referred to carbon emission reduction credits or CERCs.

According to a CARBON CREDIT system, a person or entity is awarded carbon credits to recognize actions taken that reduce the overall emission of specified greenhouse gases such as carbon dioxide. An important feature of this CARBON CREDIT system is that the carbon credits may be bought and sold in an open market, which is currently being established. These markets can be created by regulation or through voluntary efforts.

By allowing the carbon credits to be bought and sold, an incentive to reduce overall emissions is created. Regulations may be implemented which would require a party to offset any new or increased emissions with carbon credits that were either created by that entity, or purchased from a third party. Once a CARBON CREDIT is created, it remains in existence until it is redeemed or retired. A CARBON CREDIT is redeemed when it is used to offset an increase in emissions, for example by an emission source that wishes to increase its emissions, or by a source that must reduce its emissions, but cannot do so through any economically or technically feasible means. A CARBON CREDIT is retired when it is permanently taken off the market in order to reduce the overall amount of emissions, for example by an environmental group willing to pay for the reduction in emissions.

The soil has a great capacity for storing greenhouse gases such as carbon dioxide. If farmers were able to sell the carbon credits, it would create an incentive to use these practices, which should lead to a reduction in greenhouse gases and a reduced risk to insurance providers. In order to create a viable market for carbon credits it is necessary to create a system that is verifiable and that does not create large administrative costs.

Presently, sulfur dioxide is regulated in a manner that permits its emissions allowances to be bought and sold on the open market. The Chicago Board of Trade conducts auctions transferring ownership of sulfur dioxide emission allowances. There have been a few spot trades in carbon credits; however, to date there is no established market. Because of the intangible nature of carbon credits, one of the difficulties of a CARBON CREDIT market is verifiability. There must be some way of verifying that the carbon storage capacity of the same land has not been sold more than once.

Global Positioning Systems (GPS) are systems that utilizes satellites placed in orbit by the United States Government to locate with a unique set of coordinates any place on earth. With the use of a receiver that is adapted to receive and translate signals from these satellites, the location of any place on earth can be determined with a great deal of accuracy, and defined according to a set of coordinates. The coordinates are global in nature so that no two places can share the same coordinates. A Geographic Information System (GIS) is an electronic system that store and manipulate GPS coordinates data. Applicants are aware of no existing systems that utilize GPS data or GIS systems to solve the above described needs.

In summary, a need exists for a method of permitting insurance providers to gather and assimilate the information necessary to determine the risks associated with specific portions of land within a given insurable unit of land. A further need exists for a system that allows farmers to incorporate land-related data into the required reporting forms in a cost effective and expeditious manner. Finally, a need exists for a verifiable system that encourages the creation of a market for carbon credits.

The system and methods described in the present application meet these needs by proposing a GPS-based system for assimilating all relevant information related to a piece of land

### SUMMARY OF THE INVENTION

According to the present invention, each section of insurable farmland is divided into management zones. A management zone is an enclosed area of land that is internally similar with respect to crops, soils and agronomic risk determining factors. Each of these management zones is surrounded by a boundary defined by Global Positioning System (GPS) coordinates. Agronomic information related to the management zones is gathered and associated with the GPS coordinates of the management zone in a Geographic Information System (GIS) computer record. The farmer specifies in which management zones he is planting the crops being insured. This information allows insurance providers to more accurately categorize the risk associated with each insurance policy. Furthermore, because the information is associated with a unique GPS coordinate boundary, it can be used to assure that the carbon credits for any portion of land are not sold more than once. The information gathered in determining the risk level of an insurance policy for a particular management zone can also be used to determine the available carbon credits for that management zone.

Additionally, because each insurance policy will be associated with particular geographic coordinates, it will be easier for the insurance providers to track the past risk history of a particular piece of land. Therefore, if the same land is insured under different names, the insurance provider will still realize it is the same land. It will also help the insurance provider prevent double insuring of the same land, as well as other fraudulent or abusive activities.

### BRIEF DESCRIPTION OF THE DRAWINGS

FIG. 1 is a map showing an insurable parcel of land mapped to indicate soil types.

FIG. 2 is a map showing an insurable parcel of land subdivided into management zones.

FIG. 3 is a flow chart illustrating a preferred method of carbon credits solicitation.

FIG. 4 is a flow chart illustrating a preferred flow of documents in the carbon credits solicitation method of the present invention.

FIG. 5 is an example of a Summary of Potential Carbon Credit Form according to the present invention.

### DETAILED DESCRIPTION OF PREFERRED EMBODIMENTS

Described herein is an overall process for gathering agronomic information, associating that information with GPS coordinates, and using the information associated with the GPS coordinates to: (1) reduce the overall risk exposure of an entity that provides crop insurance, (2) assist farmers and related entities in meeting reporting requirements, and (3) provide a basis for identification, solicitation, documentation, verification, and marketing of carbon credits.

With respect to point (1) above, the overall risk faced by an insurance provider is reduced through a couple of mechanisms. First, the information gathered by the insurance provider with respect to the parcels of land being insured permits the insurer to more accurately estimate the risks associated with each insurance policy. Second, practices which decrease the likelihood of catastrophic crop failure are encouraged.

With respect to point (2) above, this system provides a means to assist producers/farmers, possibly for a fee, in meeting their various reporting requirements in an expeditious and efficient manner.

Finally, with respect to point (3) above, the overall profitability of the insurer, or other user of the system, may be improved by generating revenue through the sale of services related to the administration of the accumulation and verification of carbon credits (CCs). While it is preferred that the entire process be used, these applications may have value separate and apart from each other.

As an overview, the components of the invention might be generally described as: creating a map that divides a parcel of land, or field, into management zones that are homogenous with respect to relevant agronomic factors, identifying all relevant data elements, the bulk of which are agronomic in nature, defining the boundaries of the management zones with GPS coordinates, and associating the relevant data elements with their respective GPS coordinates in a GIS record. The system may be used to collect and organize information that facilitates ranking the overall risk level of providing crop insurance for an insurable unit, to aid in complying with various reporting requirements, to determine the carbon sequestering capacity of a field, and to assist in accumulating and verifying carbon credits. These components are described in more detail below.

As noted above, companies that provide MPCI in the United States are able to make allocations of what percentage of risk they will retain on policies on a policy-by-policy basis. Typically, the insurance provider may have no more than one month between the deadline for the farmers to submit their applications for crop insurance and the insurance providers deadline for making the allocation of percentage of risk to underwrite. On the insurance application, the farmer is only required to indicate how many acres in which county of what type of crop he would like insured. The farmer is not required to specify where on the insured parcel of land the crops are being planted. Therefore, presently crop insurance providers rely primarily on past average performance of a field (the insured unit), the type of crop planted (i.e., soybean, corn, wheat), and the location (county) of the field to determine the risk level of an insurance policy. If the insurance providers were also able to take into consideration the agronomic features of the actual portion of the insured land where the crops were planted, their ability to accurately assess the risks of a crop failure would be increased.

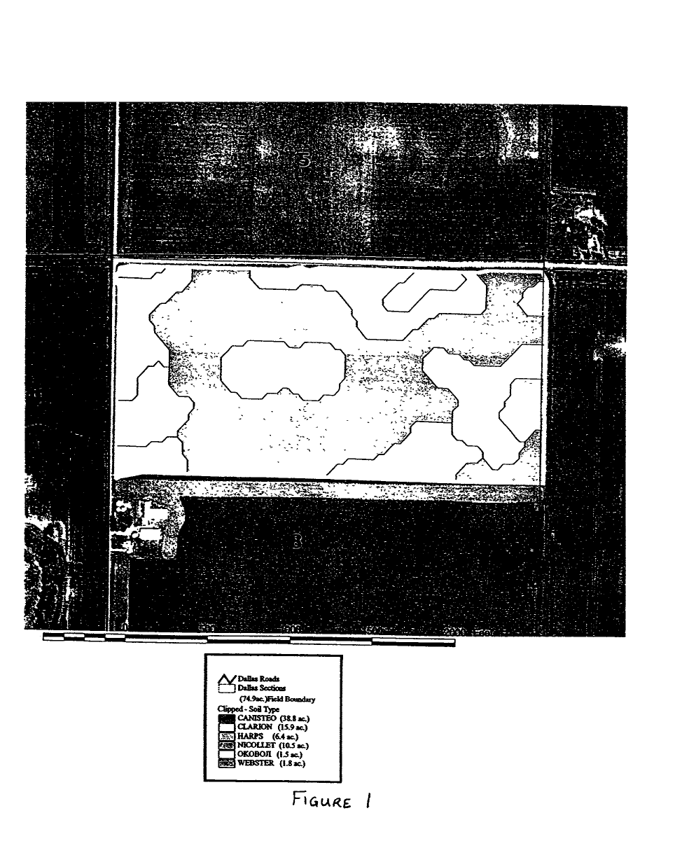

The use of GPS technology in mapping farms is a well-known practice. For the purposes of the present invention a map is needed that identifies the location of features that are important to the risk characteristics of the underlying soil. In order to create this map, the land being insured may surveyed using a GPS receiver. Typically this will involve using a GPS receiver and recording device to get a map of the boundaries of that parcel of land; however, in some instances it may be possible to convert the township-range-section information into GPS coordinates without performing a physical survey of the parcel of land. Then, either individual soil test data or publicly available soil type data is incorporated into the map. Soil-type maps are commonly available that show the location of various soil types within a parcel of land. The GPS coordinates relating to these soil types can be entered into the overall map of the parcel by either physical inspection of the parcel and use of a GPS receiver and recording device, or by directly converting the information from the soil-type maps into GPS coordinates. FIG. 1 shows a map of a field that shows the types of soil contained in the field. The field may also be surveyed for major features such as waterways, terraces and fencelines using a GPS receiver and recorder. Using this agronomic information relating to soil types and major geographic features, the field can be divided into management zones.

The present system has been designed for use with the existing GPS satellites placed in orbit and controlled by the United States Government. However the term GPS should be interpreted to include any similar future systems that might be developed.

The land within any one of these management zones should be of relatively similar risk level with respect to crop failure across the entire management zone. However, the risk of crop failure may vary greatly from management zone to management zone, even within the same field. An agronomist of ordinary skill in the art will understand how to divide the fields according to their agronomic characteristics. Preferably the fields will be divided along the boundaries of the various soil types. Some soil types have very similar risk characteristics and can be included in the same management zone if they adjoin each other.

Generally crop failure is defined as failing to meet a specified percentage of an expected yield. For example, if the field is insured for eighty percent of an expected yield of 150 bushels per acre for corn, a crop failure requiring payment of a claim would occur to the extent the average yield for the entire insured unit was less than 120 bushels per acre.

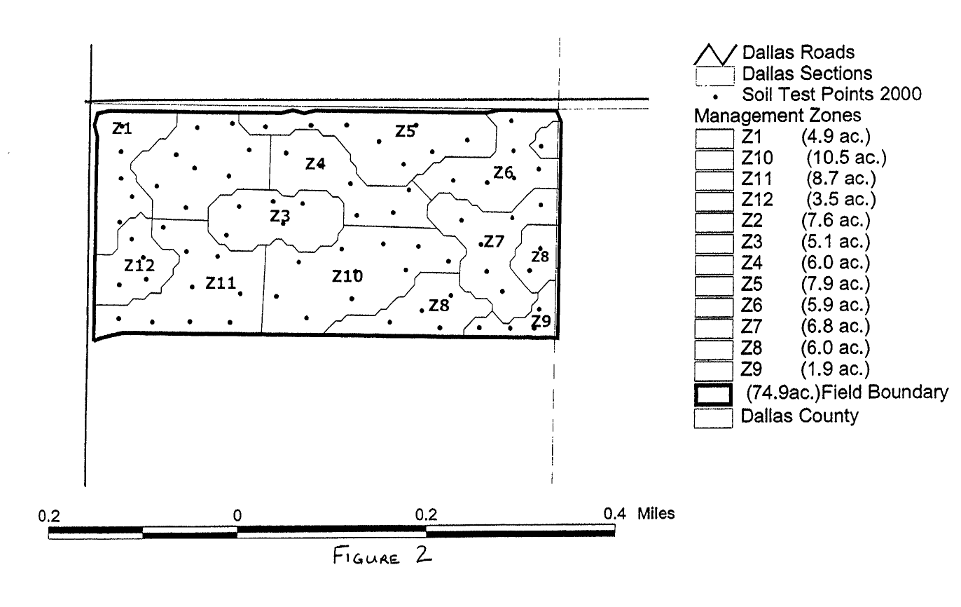

FIG. 2 shows a map divided into management zones that a farmer, or insurance agent working with a farmer, can use in obtaining the necessary information from the farmer. Preferably this map will be used with an interactive computer input screen so that farmer can just point a curser at the intended zone to select it. The map shows the farmer's field divided into management units. The farmer is requested to input for each management unit what, if any, insured crops he intends to plant within that management zone. It is expected that this will be accomplished with a graphic user interface.

Each management zone is a polygon defined by line segments joining GPS coordinates on its boundary. Each of these management zones has a separate record in a Geographic Information System (GIS). The preferred GIS is a form of a searchable data base that is adapted to handle GPS information. Each record in the GIS data base has several fields of information associated with the management zone. These fields of information permit an insurance provider to track information related to each management zone. The preferred GIS is a modified version of a data base sold under the trade name ArcView and manufactured by Esri Inc. Those of ordinary skill in the art should be aware of other data bases that can be adapted to handle GPS information.

The preferred GIS fields at a minimum will track the soil type of each management zone, the types of crops planted on the management zone, and the known yield history of the management zone. Additional agronomic information may also be included in the fields, such as samplings of the pH levels of management zones, the timing and amount of fertilizer applied within each management zone, the timing of planting and emergence within each management zone, the average cation exchange capacity of the soil in the management zone, the moisture capacity of the soil, and numerous other agronomic characteristics of which those of ordinary skill in the art will be aware.

The vastly expanded information provided to insurance providers through this process will permit the insurance providers to more accurately categorize the risk level associated with a given insurance policy. It will also expand the ability of the insurance provider to analyze risk levels based on past performance. For example, it will permit the insurance provider to compare all corn planted on a specified soil type within a specified county or counties by searching for all management zones that meet these criteria.

Crop insurance providers will be aware of numerous methods of calculating and rating risk levels based on the aforementioned information. Such determinations may involve both quantitative methods and qualitative methods.

Furthermore, this information can be used to reduce the risk of crop failure on an insured farm. For example, recommendations for types, timing, and rates of application for fertilizers and pesticides can be made based on the above noted information.

A further advantage of the present system is that it more accurate in determining the total acres planted than the traditional township-section-range method of defining a parcel of land. A further advantage is the universality of the GPS data. Some states use different nomenclature or systems for locating and defining land parcels. The use of one universal naming system allows for more uniform treatment of information.

It should be noted that presently a farmer could not be required to provide the information necessary to create and use the management zones as outlined above. However, because of the benefits available to the farmer from participating in such a system, the farmers will have an incentive to provide the information. It should also be noted that a farmer does not always know for sure in advance what type of crop will be planted on each management zone. Changes in conditions between the time the insurance is applied for and planting time can result in planting practices that vary from what was anticipated. Nevertheless, the information of what is expected to be planted typically has a high correlation to what is actually planted and is therefore a valuable predictor for what will actually be planted on the various management zones.

The incentives to the farmers to provide the information relative to what is planted on the various management zones are numerous. First, because of the accurate boundaries created by the GPS system, an accurate accounting of the actual acres being planted is provided. This is beneficial to the farmer because it prevents the farmer from over-insuring by paying for more acres than are actually planted, and it prevents the farmer from being under insured in case of crop failure if he actually plants on more acres than he insures. More importantly, much of the same agronomic information that is important in determining and reducing risks of crop failure can be used to maximize the profitability within the management zones. The information can be used, for example, to recommend timing and rates of fertilizer applications to maximize profitability.

Having noted above the voluntary nature of providing much of this data, there are various governmental regulations in place that do require reporting of certain information, and others that are under consideration that would vastly increase the reporting requirements of various data. For example, farmers involved in the federal MPCI program are already required to report their acreage planted and production harvested. Because much of the information required must be tied to the underlying land, the proposed system will aid in the collection, organization and reporting of this information. This proposed electronic GIS-based system may even facilitate a paperless flow of such data from the field to the agency requiring the information. Depending on the variety and complexity of future data reporting requirements, farmers may well have a need for a central reporting system for which they will pay a fee.

To facilitate use of the system for reporting requirements, the information fields in the individual records of the GIS would include the information relevant for the various reporting requirements. For example, if the farmer is required to report the amount of fertilizer applied, a field would be provided in each record for that information. To further facilitate the use of the system to help with reporting requirements it may be necessary or desirable to include a separate record for the entire insurable unit, in addition to the individual management zone records. The record for the entire insurable unit would include fields for information that relates to the entire insurable unit. It may be possible for the system to sum specified fields from the management zone records into corresponding fields in the insurable unit record to provide totals for the entire insurable unit. Often times it is these totals that need to be reported.

As an additional benefit for the system, the same information that is useful in assessing and reducing the risk of crop failure, is also useful in verifying carbon credits. Furthermore, the system of insurance agents and relationships with farmers that results from providing crop insurance is useful in accumulating carbon credits.

One carbon credit is the atmospheric warming equivalent of one metric ton of carbon dioxide NOT released into the atmosphere. The soil can be a large repository for storing carbon dioxide and organic carbon. The type of crop and the livestock management practices a producer uses can have a tremendous impact upon the amount of carbon stored in the soil. A carbon credit can be defined by GPS designation to provide an auditable legal location in all environments.

Plants convert atmospheric carbon dioxide into sugars and other carbon compounds in the process of growth. When a plant dies, some of the carbon dioxide it has absorbed remains as organic carbon in the form of dead roots and stalks buried in the soil. As plant material decays, carbon dioxide is released back into the atmosphere. The plant residue, (i.e., roots, stems, leaves) first break down into humus, provided the breakdown occurs in an aerobic situation. Tillage accelerates oxidation and mineralization of humus back into carbon dioxide and the other minerals it contained. By reducing tillage, the farmer reduces oxidation and mineralization rate of soil humus into carbon dioxide. The rate of crop residue breakdown and movement of atmospheric carbon dioxide into soil humus may or may not be affected by tillage, but if it is, the effect is probably minimal. The benefit of these practices is that they reduce the rate that the carbon dioxide is lost from the soil back to the atmosphere, while maintaining a constant rate of accumulation, leading to a net increase in soil carbon, and a net decrease in atmospheric carbon. Since conventional tillage and erosion accelerate plant decomposition, efforts to reduce soil tillage and erosion help increase the amount of organic carbon retained or sequestered in the soil. Reduced tillage also effects the amount of organic matter and moisture retained in the soil, which could have an impact to reduce crop losses in a dry year. A CARBON CREDIT program is environmentally friendly because it reduces harmful greenhouse gas emissions into the atmosphere, but it also reduces agricultural risk by increasing the fertility of the soil and helping to control erosion of the land.

Carbon credits are created by a change in practice or management that avoids the emission of greenhouse gases. In order to qualify as a reduction, the activity must subtract or offset emissions from a predetermined baseline. While all green plants absorb carbon dioxide and create biomass, a net addition to stored carbon is not automatic. For example, warmer, southern soils have higher microbial activity that metabolizes most or all of the organic carbon created in a growing season even with minimum tillage. Without some management change or practice change, some activities that sequester carbon are already included in the baseline calculations (e.g. existing unmanaged forests and pastureland).

Common practices that may create carbon credits in many soils and locations are: minimum and no-till tillage practices, cropland retirement, nitrogen fertilizer reduction, use of livestock manure for fertilizer and reforestation. Carbon credits may also be created by reducing fossil fuel usage.

The USDA's Natural Resource Conservation Service (NRCS) and several environmental engineering firms are developing carbon credit protocols for these practices. Protocols define how carbon credits are to be measured and calculated. The marketplace must generally accept carbon credit protocols for the carbon credits to have value.

Companies and consumers will buy carbon credits because they need or want to reduce their emissions but find it more cost effective to buy offsets rather than change their already established practices.

At the present time there are two matrices in development for the establishment of carbon credits for various practices, soil conditions, and weather environments. The information gathered for the system described above relative to assessing and reducing crop failure risks can be used to calculate carbon credits. The two matrices developed are CQESTER and C-STORE.

The CQUESTR model was developed by NRCS. According the CQUESTR model, the CARBON CREDIT storage capacity of a given piece of land is defined according the following Model Equation:

Rr=Ir×exp(k×fN×fW×fB×CDD)

Rr=Residue remaining storage capacity

Ir=Initial residue

k=Decomposition coefficient

fN=Nitrogen content factor

fW=Water factor

fB=Biomass type factor

CDD=Cumulative Degree Days

The C-STORE matrix provides an interface between complex research models and user capability. This model calculates soil organic matter changes based on their inputs. The model uses similar inputs to the CQUESTR model. Both models are expected to be available in PC software applications that would permit the transfer of data from the GIS records being developed in this proposed invention directly into the matrices for a determination of the available carbon credits.

In order for carbon credits to be a viable commodity, there must be some way of verifying that carbon credits for any given parcel of land have only been sold once. The GPS boundaries created for the management zones provide a global identifier for each management zone. GIS software permits a determination of whether any point or group of points is contained within a specified management zones. Therefore, as carbon credits are sold for a management zone, an indication is made in the GIS information that that management zone has had its carbon credits sold. If a certifying agency wishes to determine whether the carbon credits for a particular location have been sold, a search can be formed in the GIS based on the GPS coordinates of the specified location to verify that its carbon credits have not been sold previously. Because GPS coordinates are global, they define the entire set carbon credits available to be sold with unique coordinates.

An additional requirement for the value of carbon credits based on carbon sequestering is verification that the agreed to practice is still being followed. For example, if a farmer agreed to convert to no-till practices in order to create carbon credits, there needs to be some way of verifying that the farmer is actually adhering to those practices on the specified land. The network of agents and information gathering personnel needed to collected the information for the fields of the GIS records can easily provide period confirmation that the agreed to practices are being adhered to. One of the fields of information associated with each management zone can be the type of tillage practice being used on the management zone. That would permit a simple verification that the land in question is being used according to the agreed to practices.

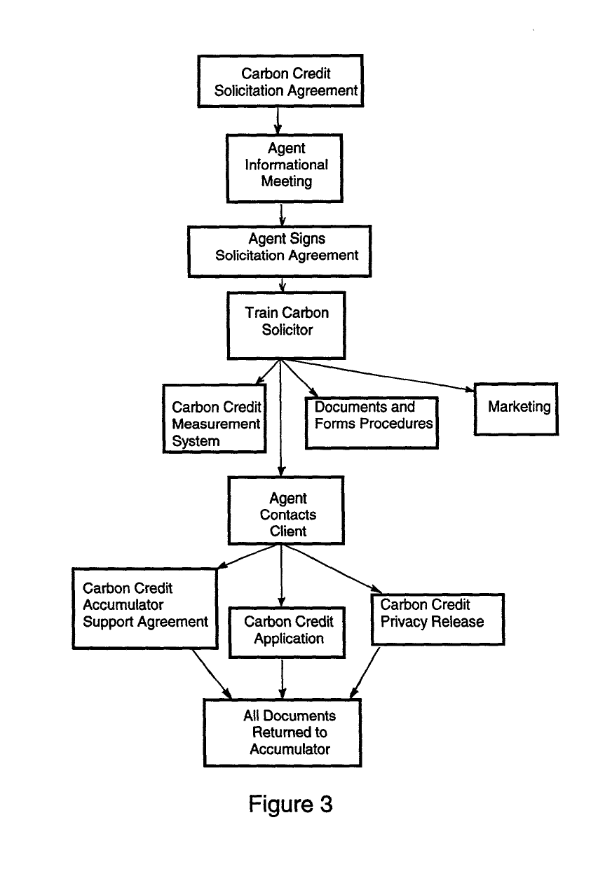

A preferred method of accumulating carbon credits for sale to third parties is outlined in the flow chart shown in FIG. 3. According to this method of accumulating carbon credits, the insurance provider would act as an accumulator, or holding agent, for carbon credits. The objective is to help producers document the number and source of their eligible carbon credits, and to provide a conduit for the sale of those carbon credits. While the preferred entity to be the accumulator is a crop insurance provider, the methods outlined herein could be used by any entity wishing to accumulate CARBON CREDIT data. The insurance provider, or other accumulator, would not buy the carbon credits or otherwise guarantee their value.

As seen in FIG. 3, the first step in the preferred process is to enlist agents who will solicit agreements with producers for the insurance provider, or other accumulator, to accumulate data related to carbon credits for the producer. Preferably the agent is already an agent that sells crop insurance for the insurance provider. Preferably a contract is signed between the agent and the accumulator that outlines the agents duties and responsibilities and provides for payment of a commission to the agent based on a percentage of the fees generated from the accumulating services. Training should be provided to the agents as to the concepts and principles involved in CARBON CREDIT establishment.

The agents will then solicit producers to sign-up acres of their agricultural land for participation in CARBON CREDIT creation. A standardized accumulator support agreement should be used by the agents to form a contract between the insurance provider and the producer. According to the terms of the accumulator support agreement, the producer requests that the insurance provider, or other accumulator, accumulate data for the purpose of formatting the data into the acceptable format necessary for establishment of carbon credits. The accumulator agrees to help in creating the documentation necessary to establish the carbon credits. The producer would be expected to pay a fee to the accumulator for these services. It may also be desirable to receive written permission from the producer to release the necessary information to the agents.

An application for carbon credits can be used to gather the information necessary to create carbon credits. The final form of the application may depend on what protocols become established as the norm in the market. At a minimum it is expected the application for carbon credits would include the GPS information locating the underlying land, the name and address of the present land owner, and a description of the activity planned to reduce or sequester carbon emissions.

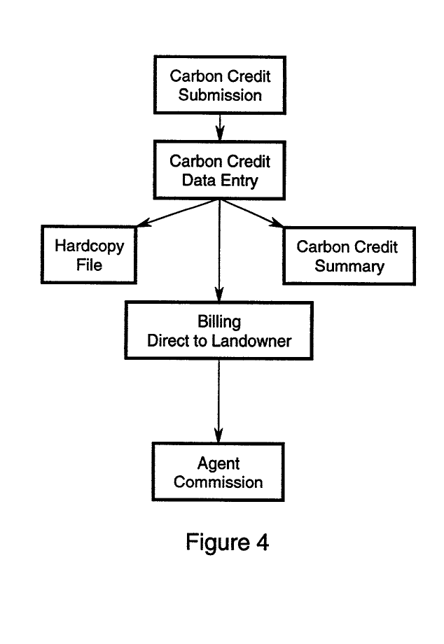

The preferred flow of documents in the CARBON CREDIT accumulation process is shown in FIG. 4. A CARBON CREDIT submission form would be submitted by the agent to the accumulator. This form may be the application referred to in the preceding paragraph, or it may be a separate form. In any event, the carbon credit submission form would contain sufficient information to permit the preparation of a Summary of Potential Emission Reduction Credit Form, as shown in FIG. 6. After the accumulator receives the CARBON CREDIT submission form, it creates the Summary shown in FIG. 6, and forwards a copy to the producer and the agent. The accumulator then bills the producer for the services in accumulating the data. After the producer pays the bill, the agent is paid a commission according to the terms of the agreement between the agent and the accumulator.

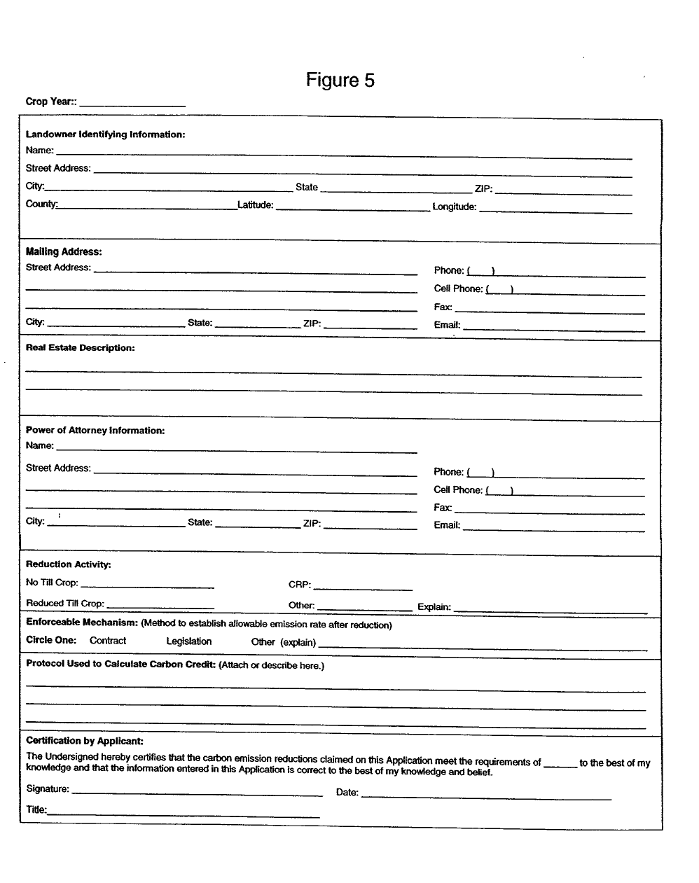

FIG. 5 shows a flow chart that describes the verification process that would be available to third parties wishing to verify the authenticity of a CARBON CREDIT. Outside entities wishing to verify the authenticity of a CARBON CREDIT could request an audit by the accumulator. The accumulator can review the fields of the GIS records to assure that the CARBON CREDIT in question is associated with only a single tract of land that is not associated with any other carbon credits. An agent of the accumulator can then inspect the land in question to verify that the agreed to practices for reducing emissions are being followed with respect to the relevant management zones. A record of the reviews can be provided to the party requesting the audit according to what ever standards the requesting party requires. A fee would be paid by the party requesting the audit to the accumulator for the verification process.

The invention claimed herein is not limited by the above description of the preferred embodiments. Those of ordinary skill in the art will recognize modifications to the preferred embodiments that remain within the scope of the invention. As such, the foregoing description should be considered illustrative rather than limiting. It is the following claims, including any equivalents thereof, which are intended to define the scope of the invention.

We claim:

1. A method for organizing information relating to a parcel of land, said method comprising:
creating a map of the parcel of land having a boundary defined by line segments connecting GPS coordinates;
creating an electronic GIS record utilizing said GPS coordinates of said boundary, said electronic GIS record having fields suitable for input of information related to the parcel of land; and
inputting information related to the parcel of land into said fields of said GIS records.

2. The method according to claim 1, wherein said information related to the parcel of land is agronomic information useful in predicting the risk of a crop failure.

3. The method according to claim 3, wherein said agronomic information includes a classification of the soil type within said parcel of land.

4. The method according to claim 2, wherein said information related to the parcel of land is useful for satisfying reporting requirements.

5. The method according to claim 1, further comprising:
subdividing said map of the parcel of land into management zones, each of said management zones having a boundary defined by line segments connecting GPS coordinates;
creating a GIS record for each of said management zones utilizing said GPS coordinates of said corresponding management zone boundary, each of said GIS records for said management zones having at least one field suitable for input of information related to a corresponding management zone; and
inputting information related to a first management zone into a field corresponding to said first management zone.

6. A method of gathering information to rank the risk associated with providing crop insurance for crops planted on a plurality of insurable parcels of land, the method comprising:
subdividing a map of each insurable parcel of land into management zones, wherein each management zone is generally internally homogenous with respect to at least one risk factor;
defining a boundary for each of said management zone according to GPS coordinates; and
creating an electronic GIS record associated with each management zone, each of said GIS records including information specific to the associated management zone and relevant to evaluating the risk associated with providing crop insurance that includes the associated management zone.

7. A method for gathering and organizing information to assist in assessing and reducing the risk faced by a crop insurance provider in insuring against crop failure for a plurality of parcels land, said method comprising:
dividing a map of each parcel of land into management zones, each of said management zones being internally homogeneous with respect to at least one agronomic risk factor, said management zones having boundaries defined by GPS coordinates;
creating an electronic GIS record with respect to each management zone, each electronic GIS record having fields associated therewith for the input of data; and
inputting relevant risk data related to each management zone into said associated fields in said GIS records.
